(19) United States
(12) Patent Application Publication
(10) Pub. No.: US 2017/0348947 A1
(43) Pub. Date: Dec. 7, 2017

(54) ULTRAHIGH MOLECULAR WEIGHT POLYETHYLENE ADHESIVE TAPES

(71) Applicant: DSM IP ASSETS B.V., Heerlen (NL)

(72) Inventors: David CORDOVA, Echt (NL); Roelof MARISSEN, Echt (NL); Johan Albert Frans KUNST, Echt (NL); Johannes Petrus Marinus PLUG, Echt (NL); William Adrianus Cornelis ROOVERS, Echt (NL)

(21) Appl. No.: 15/536,932

(22) PCT Filed: Dec. 18, 2015
(86) PCT No.: PCT/EP2015/080489

§ 371 Date: Jun. 16, 2017

Related U.S. Application Data
(60) Provisional application No. 62/094,363, filed on Dec. 19, 2014.

(30) Foreign Application Priority Data
Jan. 9, 2015 (EP) 15150634.2

(51) Int. Cl. B32B 27/06; B32B 5/18; B32B 7/12; B32B 7/14; C09J 7/02; B32B 27/12; B32B 27/32; B32B 27/34; B32B 27/36; B32B 29/00; B32B 5/02; B32B 27/10

(52) U.S. Cl. CPC B32B 27/065; B32B 5/024; B32B 5/18; B32B 7/12; B32B 7/14; B32B 27/10; B32B 27/12; B32B 5/022; B32B 27/325; B32B 27/34; B32B 27/36; B32B 29/002; C09J 7/0275; C09J 7/0296; B32B 27/32; B32B 2255/26; B32B 2255/12; B32B 2255/10; B32B 2255/02; B32B 2266/0214; B32B 2307/306; B32B 2307/518; B32B 2307/54; B32B 2307/581; B32B 2307/706; B32B 2405/00; B32B 2556/00; C09J 2201/606; C09J 2201/622; C09J 2400/263; C09J 2421/00; C09J 2423/046; C09J 2467/006; C09J 2433/00

(57) ABSTRACT

The invention relates to an adhesive tape comprising an adhesive tape comprising a layer A comprising at least one anisotropic tape, wherein said tape comprises ultrahigh molecular weight polyethylene; and a layer B comprising a first adhesive being a pressure sensitive adhesive, wherein layer A covers at least 60% of the surface area of layer B. The invention also relates to the use of said adhesive tape in different applications.

The present invention relates to an adhesive tape comprising a layer comprising ultrahigh molecular weight polyethylene and a layer comprising an adhesive. Furthermore, the present invention relates to the use of said adhesive tape in different applications.

Such an adhesive tape comprising a layer comprising a UHMWPE film and a layer comprising an adhesive is known in the prior art, for instance from document JP2003277702. Such adhesive tapes known in the art have substantially isotropic properties in one plane, thus said adhesive tapes can be loaded in two directions (i.e. longitudinal and transversal) and therefore they cannot be used in all types of applications, especially in applications that need high strength in the longitudinal or in the transversal direction. The known adhesive tapes also show low load transfer capacity between adherent surfaces and have limited peeling strength when adhering on different types of substrates.

The objective of the present invention is therefore to provide an adhesive tape that has improved properties when compared to the known adhesive tapes. In particular, to provide an adhesive tape that has at least one of the following properties: higher strength in longitudinal and/or transversal direction, giving the possibility of fully utilizing the strength of the adhesive tape and therefore also using said tape in other applications than the applications already known in the prior art, it shows higher load transfer capacity between adherent surfaces and higher degree of peeling strength on different types of substrates, it is stronger and in the same time has a low degree of fibrillation and splitting.

This objective was achieved by providing an adhesive tape comprising: a) a layer A comprising at least one anisotropic tape, wherein said anisotropic tape comprises ultrahigh molecular weight polyethylene and layer A covers at least 60% of the surface area of layer B and b) a layer B comprising a first adhesive being a pressure sensitive adhesive.

Surprisingly, the adhesive tape according to the present invention has higher strength in longitudinal and/or transversal direction, giving the possibility of fully utilizing its strength and therefore also using said tape in other applications (e.g. structural repair) than the applications already known in the prior art, it is stronger despite its multi-layer structure, it shows higher load transfer capacity between adherent surfaces and higher degree of peeling strength on different types of substrates (i.e. higher adhesion force on a substrate, including on low energy substrates, also at harsh environmental conditions), and in the same time has a low degree of fibrillation and of splitting, particularly in its length direction. Additional advantages of the adhesive tape according to the present invention include higher thermal conductivity.

Documents WO2009/008922A2 and WO2010/090627A2 describe ballistic panels comprising a sheet comprising plurality of interleaved and angularly disposed layers of non-fibrous UHMWPE tapes bonded to each other by hot melt adhesives to merely prevent overlap of the tapes in the sheet. Also, document EP0397013A2 discloses a laminate prepared by laminating an oriented UHMWPE onto a hot melt adhesive layer. However, none of these documents discloses an adhesive tape nor an adhesive tape comprising at least one anisotropic tape comprising ultrahigh molecular weight polyethylene and a ratio of tensile strength in longitudinal direction to tensile strength in transversal direction of at least 10; and a first adhesive being a pressure sensitive adhesive.

By “adhesive” is meant herein a substance capable of holding two materials together by surface treatment.

By “tape” is herein understood an elongated body having a length dimension, a width dimension and a thickness dimension, wherein the length dimension of the tape is at least about the same as its width dimension but preferably greater than its width dimension, and wherein said length dimension is much greater than its thickness dimension. Preferably, the term tape also comprises the embodiments of a ribbon, a strip, a film and may have a continuous or a discontinuous length with a regular or an irregular cross-section. Preferably, the width dimension of the tape is much greater than its thickness dimension. Preferably, the ratio of width to thickness is at least 10, more preferably at least 50, even more preferably at least 100, and most preferably at least 500. By width is herein understood the largest dimension between two points on the perimeter of a cross-section of the tape, said cross-section being orthogonal to the length of the tape. By thickness is herein understood a distance between two points on the perimeter of said cross-section, said distance being perpendicular on the width of the tape. The width and the thickness of a tape can be measured according to known methods in the art, e.g. with the help of a ruler and a microscope or a micrometer, respectively.

By “adhesive tape” is meant herein a multilayer tape that can adhere to any type of substrate.

By “pressure sensitive adhesive” (PSA) is meant herein adhesives that are normally tacky at room temperature (e.g. at a temperature of at least 15 and at most 30° C.) and firmly adhere to a wide variety of dissimilar surfaces upon mere contact without the need for more than finger or hand pressure, thus without the need of applying heat to said adhesive or increasing its application temperature and thus without the need of applying said adhesive in molten state to surfaces. By “tacky” is meant herein a state at which the adhesive is capable of forming a bond with a substrate at just contact. Another suitable definition of pressure sensitive adhesives is that PSA are adhesives which form bonds when pressure is applied (also known as self-stick adhesives). The term “pressure sensitive adhesive” is generally known to the skilled person in the art.

By “hot melt adhesive” is meant herein adhesives that are solid at room temperature (e.g. at a temperature of at least 15 and at most 30° C.) and are applied to a substrate while in molten state. In another words, hot melt adhesives are adhesives that wet out and form bonds when applied on a substrate at a temperature equal or higher than their melting temperature. The bond typically delivers full strength after solidification due to cooling to room temperature. The term “hot melt adhesive” is generally known to the skilled person in the art.

The term “film” is generally known to the person skilled in the art as typically being a thin and flexible layer of a material.

By “anisotropic” is meant herein that two mutually perpendicular directions can be defined in the plane of the tape for which the ratio of tensile strength of the oriented (adhesive) tape in longitudinal direction (i.e. first direction) to tensile strength of the tape in transversal direction (the direction perpendicular to the first direction) is at least 10 for the tape in layer A and at least 5 for the adhesive tape. Said first direction of the anisotropic tape is also known in the art to as machine direction or drawing direction (or as direction of orientation). The term “anisotropic” may be also interchangeable used herein as the tem “oriented”.

Preferably, layer A in the adhesive tape according to the invention consists of at least one anisotropic tape. More preferably, layer A in the adhesive tape according to the invention consists of at least one anisotropic tape, the tape consisting of UHMWPE. The layer A may be referred herein as the support layer or the layer that confers strength to the adhesive tape.

Preferably, the ratio of tensile strength of the at least one anisotropic tape in layer A in the longitudinal direction to tensile strength of said tape in layer A in the transversal direction is at least 20, more preferably at least 30, even more preferably at least 50 and most preferably at least 80. Lower values of said ratio give lower strength in longitudinal or transversal direction and in the same time lower transfer capacity between adherent surfaces and lower degree of peeling strength of the adhesive tape on various substrates. Preferably, the ratio of tensile strength of said tape in longitudinal direction to tensile strength of said tape in transversal direction is at most 100. Higher ratio values may destroy the transverse properties of the adhesive tape. The tensile strength may be measured according to the method described in the METHODS OF MEASUREMENT section herein below.

Preferably, layer A covers at least 70%, even more preferably at least 80%, and most preferably at least 90% and yet most preferably at least 95% of the surface area of layer B. Most preferably, layer A covers at most 100% of the surface area of layer B. Lower values may result in lower transfer capacity between adherent surfaces of the adhesive tape and lower degree of peeling strength of the adhesive tape on different types of substrates.

The thickness of the tape in layer A may be in a range of at least 0.005 mm (5 microns) and at most 0.5 mm (500 microns) and preferably in a range of 0.015 mm (15 microns) and 0.3 mm (300 microns), even more preferably in a range between 0.02 mm (20 microns) and 0.15 mm (150 microns), more preferably in a range between 0.025 mm and 0.1 mm, yet more preferably in a range between 0.025 mm (25 microns) and 0.08 mm (80 microns) and most preferably, in a range between at least 0.03 mm (30 microns) and at most 0.05 mm (50 microns).

The width of the tape in layer A may vary depending on its applications. For instance, the tape may have a width of between 2 mm and 1 m, preferably between 4 mm and 300 mm, more preferably between 20 mm and 200 mm, even more preferably between 30 mm and 150 mm and most preferably between 40 mm and 120 mm.

The width and the length of layer A or of the tape in layer A is substantially the same as the width and the length of the adhesive tape. The dimensions of width (w) and length (I) of the layer A or of the tape in layer A are thus dependent on the dimensions of the adhesive tape of the invention, which in turn are dependent on its application. The skilled person can routinely determine the lateral dimensions w and l of said layer A or of the tape in layer A.

The layer A may comprise one anisotropic tape (which is also referred to herein as “single tape”) or at least two anisotropic tapes (which is also referred to herein as “a plurality of tapes”). The layer A preferably comprises or consists of one layer of anisotropic tape comprising UHMWPE. Said plurality of tapes may be stacked such that the directions of orientation, i.e. the machine directions, of the tapes in two adjacent monolayers is under an angle α of preferably between 45 and 135°, more preferably between 65 and 115° and most preferably between 80 and 100°. A method of preparing such tapes is disclosed for example in WO2010/066819, which is incorporated herein by reference. The tapes of the plurality of tapes may be woven into a woven layer. Suitable woven structures include plain weaves, basket weaves, satin weaves. Most preferably, the woven structure is a plain weave. Preferably, the thickness of the woven layer is between 1.5 times the thickness of a tape and 3 times the thickness of a tape, more preferably about 2 times the thickness of the tape comprising the UHMWPE.

The single tape or the tapes of the plurality of tapes is/are preferably unidirectional aligned in preferably at least one layer, with their lengths defining and being contained by a single plane. A gap may exist between two adjacent tapes, said gap being preferably at most 10%, more preferably at most 5%, most preferably at most 1% of the width of the narrowest of said two adjacent tapes. Preferably, the plurality of tapes are in an abutting relationship. More preferably, layer A comprises adjacent tapes that overlap each other along their length over part of their surface, preferably the overlapping part being at most 50%, more preferably at most 25%, most preferably at most 10% of the width of the narrowest of said two overlapping adjacent tapes. Preferably, layer A contains at least one anisotropic unidirectional aligned tape, wherein at least 70 mass % of the total mass of tapes in said layer, more preferably at least 90 mass %, most preferably about 100 mass %, run along a common direction. Preferably, the direction of orientation of more than two anisotropic tapes in layer A comprising unidirectional aligned tapes is at an angle β to the direction of orientation of the tapes in an adjacent layer, whereby β is preferably between 5 and 90°, more preferably between 45 and 90° and most preferably between 75 and 90°.

The plurality of tapes may also form a sheet. The sheet may comprise at least 2 layers of anisotropic tapes or at least one woven layer of anisotropic tapes. Preferably, the sheet consists of 2 layers of anisotropic tapes or one woven layer of a plurality of anisotropic tapes. Preferably, the direction of orientation of the anisotropic tapes in 2 adjacent layers differ by an angle β, whereby β is preferably between 5 and 90°, more preferably between 45 and 90° and most preferably between 75 and 90°. The method to prepare said sheet is not limited to any specific process. Such sheets may be produced by providing at least one layer containing at least one tape with a tensile strength of at least 0.8 GPa as measured according to the method described in the METHODS OF MEASUREMENT section herein below and an areal density of between 5 and 300 g/m², and then stacking the at least one layer with tape to form a sheet. Optionally, said process may further comprise a heating and/or compression step. The temperature during compression generally is typically controlled through the temperature of the rolls or the press. Applying a heating and/or compression step has the advantage that the sheet shows improved integrity, i.e. the sheet is less prone to disintegrate into its individual components.

The at least one anisotropic tape in the layer A comprises or consists of UHMWPE and optionally, any conventional additives (i.e. additives common in the art to be added in UHMWPE) in any conventional amounts (i.e. common amounts of additives common in the art to be added in UHMWPE), such as various fillers, pigments and additives, stabilizers, e.g. ultraviolet (UV) stabilizers, colorants, pigments, e.g. white pigment, dyes, promoters. The amount of the various fillers, pigments and additives may be between 0 wt % and 30 wt %, more preferably between 0.05 and 10 wt %. Preferably, layer A comprises at least one anisotropic tape, wherein the tape consists of ultrahigh molecular weight polyethylene and optionally conventional additives.

The ultrahigh molecular weight polyethylene may be linear or branched, although preferably linear polyethylene is used. Linear polyethylene is herein understood to mean polyethylene with less than 1 side chain per 100 carbon atoms, and preferably with less than 1 side chain per 300 carbon atoms; a side chain or branch generally containing at least 10 carbon atoms. Side chains may suitably be measured by FTIR. The linear polyethylene may further contain up to 5 mol % of one or more other alkenes that are copolymerisable therewith, such as propene, butene, pentene, 4-methylpentene, octene. Preferably, the linear polyethylene is of high molar mass with an intrinsic viscosity (IV, as determined on solutions in decaline at 135° C.) of at least 4 dl/g; more preferably of at least 8 dl/g, most preferably of at least 10 dl/g. Such polyethylene is also referred to as ultrahigh molecular weight polyethylene. Intrinsic viscosity is a measure for molecular weight that can more easily be determined than actual molar mass parameters like Mn and Mw.

The at least one anisotropic tape in layer A in the adhesive tape according to the invention may be prepared in a number of ways, already described in the art.

A preferred method for the production of said tape is a process that takes place in solid state, which comprises feeding UHMWPE powder between a combination of endless belts, compression-moulding the polymeric powder at a temperature below the melting point thereof and rolling the resultant compression-moulded polymer followed by drawing. Such a method is for instance described in U.S. Pat. No. 5,091,133, which is incorporated herein by reference. If desired, prior to feeding and compression-moulding the polymer powder, the polymer powder may be mixed with a suitable liquid organic compound having a boiling point higher than the melting point of said polymer. Compression-moulding may also be carried out by temporarily retaining the polymer powder between the endless belts while conveying them. This may for instance be done by providing pressing platens and/or rollers in connection with the endless belts. The tape obtained is also known as “solid state tape”. Preferably, the anisotropic tape in layer A is a solid state tape. Preferably, layer (A) in the adhesive tape according to the present invention comprises or consists of a solid state tape comprising UHMWPE. Such solid state tape has a homogenous structure, which gives more uniform strength distribution in the adhesive tape.

Another preferred method for the production of the at least one anisotropic tape in layer A is by melt-spinning and comprises feeding UHMWPE powder to an extruder, extruding a tape at a temperature above the melting point thereof and drawing the extruded polymer tape below its melting temperature to obtain a melt-spun UHMWPE tape. The melt-spun UHMWPE tape obtained is typically substantially free of any solvent.

In yet another preferred method, the at least one anisotropic tape in layer A are prepared by a gel spinning process, e.g. the tapes comprise gel spun UHMWPE. A suitable gel spinning process is described in for example GB-A-2042414, GB-A-2051667, EP 0205960 A and WO 01/73173 A1, and in “Advanced Fibre Spinning Technology”, Ed. T. Nakajima, Woodhead Publ. Ltd (1994), ISBN 185573 182 7. In short, the gel spinning process comprises preparing a solution of a polymer of high intrinsic viscosity, such as UHMWPE, extruding the solution into a tape at a temperature above the dissolving temperature, cooling down the film below the gelling temperature, thereby at least partly gelling the tape, and drawing the tape before, during and/or after at least partial removal of the solvent. The (UHMWPE) product obtained, i.e. tape comprising UHMWPE may contain some solvent at ppm level, for instance at most 500 ppm.

In the described methods to prepare said tape, the drawing, preferably uniaxial drawing, of the produced tape may be carried out by any means known in the art. Such means comprise extrusion stretching and tensile stretching on suitable drawing units. To attain increased mechanical strength and stiffness, drawing may be carried out in multiple steps. Preferably, drawing of ultrahigh molecular weight polyethylene tapes is typically carried out uniaxially in a number of drawing steps. The first drawing step may for instance comprise drawing to a stretch factor of 3. Multiple drawing may typically result in a stretch factor of 9 for drawing temperatures up to 120° C., a stretch factor of 25 for drawing temperatures up to 140° C., and a stretch factor of 50 for drawing temperatures up to and above 150° C. By multiple drawing at increasing temperatures, stretch factors of about 50 and more may be reached.

Yet another preferred method for the preparation of the tape in layer A comprises mechanical fusing of unidirectional oriented fibers under a combination of pressure, temperature and time. Such a tape and a method to prepare such a tape are described in EP2205928, which is incorporated herein by reference. Preferably, the unidirectional oriented fibers comprise ultrahigh molecular weight polyethylene (UHMWPE). UHMWPE fibres consisting of polyethylene filaments that have been prepared by a gel spinning process, such as described, for example, in GB 2042414 A or WO 01/73173 A1, are preferably used. A gel spinning process essentially consists of preparing a solution of a linear polyethylene with a high intrinsic viscosity, spinning the solution into filaments at a temperature above the dissolving temperature, cooling down the filaments to below their gelling temperature, such that gelling occurs, and stretching the filaments before, during and/or after the removal of the solvent.

The areal density of the at least one anisotropic tape in layer A of the adhesive tape according to the present invention can be selected within a wide range. However the areal density of the tape does preferably not exceed 500 g/m², more preferably does not exceed 300 g/m², even more preferably does not exceed 100 g/m², even more preferably does not exceed 50 g/m². For practical reasons, such areal density will preferably be at least 5 g/m², more preferably at least 10 g/m². Good performance is achieved if the areal density does not exceed 250 g/m² and more preferably does not exceed 100 g/m².

The strength of the at least one anisotropic tape in layer A may be at least 0.8 GPa, preferably at least 1.2 GPa, even more preferably at least 1.8 GPa, even more preferably at least 2.1 GPa, and most preferably at least 3 GPa, as measured according to the method described in the METHODS OF MEASUREMENT section herein below.

The anisotropic tape in layer A may be surface treated by using any method known in the art in order to obtain at least one anisotropic tape comprising UHMWPE and having higher surface tension, e.g. by applying Corona treatment, plasma treatment, flame treatment, oxidation treatment, applying an adhesion promoter or by activating the tape surface by using a primer solution or by adding a compatibilizer, such as a polymer, e.g. maleic anhydride grafted polyethylene or a resin such as Yparex® or by treating it with water-based polyolefinic dispersions. The at least one anisotropic tape in layer A may have a contact angle higher than 84.5°, preferably at least 85°, yet more preferably at least 90° and most preferably at least 95°, and yet most preferably at least 98°, as measured according to the method described in the METHODS OF MEASUREMENT section herein below. By using such a tape, higher hydrophobicity of the adhesive tape is obtained. By applying a surface treatment, preferably a corona treatment, the at least one anisotropic tape can be produced at stable process conditions and the adhesive tape obtained does not tear, particularly in its length direction, does not wrinkle and does not laminate. This makes clean-cutting of the final adhesive tape easier.

The layer B in the adhesion tape according to the present invention comprises a first adhesive that is a pressure sensitive adhesive that may be in solid or liquid state. Suitable examples of first adhesive include acrylic-based adhesives, particularly adhesives based on (poly)(meth)acrylic resins, rubber-based adhesives or water-based adhesives. Preferably, the first adhesive is an acrylic-based adhesive. Any pressure sensitive adhesives known in the art may be used in the adhesive tape according to the present invention. Suitable examples of acrylic-based adhesives include any acrylic based adhesive known in the art, that can be made by any method known to the skilled person in the art e.g. homopolymers made of monomers selected from (meth)acrylic monomers such as (meth)acrylic acid; alkyl (meth)acrylates such as methyl (meth)acrylate, ethyl (meth)acrylate, butyl (meth)acrylate, 2-ethylhexyl (meth)acrylate and iso-octyl (meth)acrylate; mono(meth)acrylates such as 2-hydroxyethyl (meth)-acrylate; di(meth)acrylates such as diethylene glycol di(meth)acrylate and hexanediol di(meth)acrylate; tri(meth)acrylates such as pentaerythritol tri(meth)acrylate; (meth)acrylamides such as (meth)acrylamide and N,N-dimethyl(meth)acrylamide; and multifactorial polymers such as copolymers and terpolymers made of two or more kinds of monomers selected from the above-mentioned (meth)acrylic monomers. Further, examples of usable polymers include copolymers of the above-mentioned (meth)acrylic monomer and a vinyl compound other than the (meth) acrylic monomer such as vinyl acetate, N-vinylpyrrolidone, N-vinylpiperidone, N-vinylcaprolactam or styrene. The pressure sensitive examples used in the adhesive tape according to the invention may be made by any method known in the art. Pressure sensitive adhesives and methods to prepare them are generally described for instance in document US20150344747, U.S. Pat. No. 5,874,143A, U.S. Pat. No. 5,308,887A, EP19980114808, which are incorporated herein by reference.

The layer B may have a thickness in a range between 0.005 mm and 1 mm. Preferably, the thickness of layer B is higher than 0.01 mm, yet preferably at least 0.02 mm, more preferably lower than 0.3 mm, yet more preferably lower than 0.1 mm. The thickness of layer B is preferably lower than 0.7 mm, more preferably lower than 0.5 mm, most preferably in a range between 0.025 mm and 0.1 mm and yet most preferably in a range between 0.03 mm and 0.07 mm.

The adhesive tape according to the present invention may further comprises a layer C comprising a carrier. The layer C preferably consists of a carrier. When layer C is present, the first adhesive or the second adhesive may also be referred to herein as the bonding layer between layer A and layer C. By using of the carrier, splitting or tearing of the adhesive tape particularly in longitudinal direction and fibrillation of the adhesive tape are diminished. The carrier in layer C may be any material having substantially isotropic properties or isotropic properties, meaning that the material has (substantially) the same mechanical properties in all directions in-plane. Suitable examples of such material include polymers, like a polyester, e.g. polyethylene terephthalate (PET), a polyamide, a polyolefin, e.g. a polypropylene, e.g. biaxially oriented polypropylene or a polyethylene, polycarbonates and blends thereof; paper, a tissue, a polymeric foam, woven fabric, a non-woven material, e.g. veils of glass, PET, nylon, cellulose-based materials and/or any mixtures of these materials. All these material may be provided with a release agent on top facing the outside; examples of a release agent may include silicon-based or fluor-based polymers. The carrier can also be a thin woven structure e.g. a web or a scrim comprising a polymer. The titer of the yarn from which the woven structure may be made is preferably lower than 110 dtex. Preferably, the carrier is PET as the adhesive tapes in which PET is used as carrier shows a lower degree of splitting particularly in length direction, lower degree of fibrillation and higher level of peeling strength on various types of substrates.

The layer C may have a thickness in a range between 0.005 mm and 1 mm. Preferably, the thickness of layer C is higher than 0.01 mm, yet preferably higher than 0.02 mm, more preferably lower than 0.3 mm, yet more preferably lower than 0.1 mm. The thickness of layer C is preferably lower than 0.7 mm, more preferably lower than 0.5 mm, most preferably in a range between 0.025 mm and 0.1 mm and yet most preferably in a range between 0.03 mm and 0.07 mm. Thinner layer C may be difficult to produce and the adhesive tapes will split and/or fibrillate and will be less strong. Thicker layer C may result in adhesive tapes that are too bulky (e.g. have too high areal density values) and are difficult to be applied on a substrate.

The adhesive tape according to the present invention may further comprise a layer D, the layer D comprising a second adhesive. The layer D preferably consists of a second adhesive. The second adhesive in layer D may be a compound selected from a group comprising or consisting of a pressure sensitive adhesive, a hot melt adhesive, a thermoset polymer including a room temperature-cured thermoset polymer, an elastomer and thermoplastic polymers. Pressure sensitive adhesives and hot sensitive melt adhesives are well-known to the skilled person in the art. Suitable examples of pressure sensitive adhesives include acrylic-based adhesives, rubber-based adhesives, water-based adhesives, solvent-based adhesive, thermoplastic polymer-based adhesives and/or mixtures thereof. Preferably, the second adhesive is a pressure sensitive adhesive, more preferably a (meth)acrylic-based adhesive.

Any hot melt adhesives known in the art can be used in the present invention. Hot melt adhesives and their production methods are widely described in prior art, for instance in documents EP0397013A2, U.S. Pat. No. 5,360,854 A, WO2010/090627A2 and WO2009/008922A1. Hot melt adhesives are typically grouped in the prior art into two types: hot melt pressure sensitive adhesives which are tacky to the touch even after the adhesive has solidified and non-tacky hot melt pressure sensitive adhesives. Hot melt adhesives are typically first melted in a melt tank and then applied e.g. by coating in a molten state at the final location where the bond is required. Molten adhesives may be applied in molten state on different substrates typically by spraying or coating as films or thin layers preferably at a temperature below the melting temperature of substrates. Suitable examples of hot melt adhesives may include (co-) polymers, such as polyolefins (e.g. ethylene- or propylene-based (co-)polymers); polyamides; functionalized polyolefins (e.g. ethylene or propene copolymers with oxygen containing monomers; polyolefins modified with unsaturated carboxylic acids); ethylene vinyl acetate copolymer; polyurethanes; ethylene acrylic acid copolymer; styrenic block copolymers containing at least one rubbery phase, e.g. styrene-isoprene-styrene copolymers, styrene-butadiene-styrene copolymers; amorphous polypropylene (APP); amorphous poly-alpha olefins that are generally produced using Ziegler-Natta catalysis and can be made using a variety of monomers, including but not limited to propylene, ethylene and butene. In addition, various copolymers and terpolymers that may be used as hot melt adhesives are produced by a number of manufacturers, including Evonik Industries, who produce the Vestoplast® polymers; REXtac, LLC, who produces the Rextac® range of materials, and Eastman Chemical, manufacturers of the Eastoflex® line of polymers. The hot melt adhesive may be combined with various additives, such as tackifiers, plasticizers, waxes and fillers. Preferably, the hot melt adhesive in the adhesive tape according to the present invention is a polyolefin, more preferably a polyethylene, and most preferably low density polyethylene (LDPE).

The layer D may have a thickness in a range between 0.005 mm and 1 mm. Preferably, the thickness of layer D is at least 0.01 mm, yet preferably at least 0.02 mm, and more preferably at most 0.1 mm, yet more preferably at most 0.3 mm. The thickness of layer D is preferably at most 0.7 mm, more preferably at most 0.5 mm and most preferably at most 0.3 mm. The thickness of layer D is preferably between 15 microns (0.015 mm) and 300 microns (0.3 mm), more preferably between 25 microns (0.025 mm) and 200 microns (0.2 mm), still more preferably between 15 microns (0.015 mm) and 70 microns (0.07 mm) and most preferably in a range between 0.025 mm and 0.08 mm and yet most preferably in a range between 0.03 mm and 0.07 mm. Thinner layer D are difficult to produce. Thicker layer D results in adhesive tapes that are too bulky (e.g. have too high areal density values) and are difficult to be applied on a substrate.

The first and the second adhesive in the adhesive tape according to the present invention may be different or the same type.

The adhesive tape according to the present invention may further comprise a layer E comprising a material. The layer E has typically the role of releasing the adhesive tape to be applied on a surface and therefore may also be referred herein to as “release liner”. Preferably, layer E comprises a material that does not adhere to the second adhesive, like cellulose-based, paper, e.g. siliconised paper, a polymer such as a fluoropolymer or long chain alkyls, a metal, such as aluminium. Preferably, layer E consists of said materials. Layer E is typically removed at the application of the adhesive tape on a substrate.

The thickness of layer E may be in a range between 0.01 mm and lower than 5 mm. Preferably, the thickness of layer E is lower than 2 mm, more preferably lower than 1 mm, most preferably lower than 0.5 mm and yet most preferably in a range between 0.1 mm and 0.5 mm. Too thick layer E may cause too bulky adhesive tape. Too thin layer E may be too weak and it may tear away.

It is not essential for the present invention that the thickness of the individual layers A-E in the adhesive tape is substantially the same at every location thereon. However, for ease of manufacturing and application of the adhesive tape on different substrates, it is preferred that the thickness of the layers when measured at various locations of said layers is about the same.

Preferably, the ratio of tensile strength of the adhesive tape in longitudinal direction to tensile strength of the adhesive tape in transversal direction is at least 5, preferably at least 30, more preferably at least 50, yet more preferably at least 100 and most preferably at least 150, as measured according to the method described in the METHODS OF MEASUREMENT section herein below.

Each layer forming the adhesive tape according to the present invention typically has an upper surface (herein may also be referred to as “upper side”) and a lower surface (herein may also be referred to as “lower side”) opposite to the upper surface. It goes without saying that although called upper surface and lower surface, these denominations are not limiting and they are interchangeable.

The layers A-E in the adhesive tape according to the present invention can form a stack, said stack having an upper-stack surface and a lower-stack surface opposite to the upper-stack surface, wherein said upper-stack surface is one layer E and the lower-stack surface is one layer A (e.g. in case of a single sided adhesive tape) or said upper-stack surface and said lower stack surface are each one layer E, with layer A being the core (e.g. in case of a double sided adhesive tape). Preferably, the adhesion tape according to the present invention is a five layers stack adhesive tape consisting of layer A, layer B, layer C, layer D and layer E. It goes without saying that although called upper-stack surface and lower-stack surface, these denominations are not limiting and they are interchangeable.

The adhesive tape according to the present invention may comprise or consist of a layer A, a layer B and optionally a layer E. Such an adhesive tape may be also referred to herein as an one sided adhesive tape (i.e. it adheres with only one side on a surface).

Preferably, the adhesive tape according to the invention comprises a layer A located between a layer B and the outside, a layer B on top of layer A or a layer B located between layer A and optionally layer E. When layers C and D are also present in the adhesive tape, the adhesive tape according to the invention comprises a layer A located between layer B and the outside, with layer A being the outmost upper layer of the adhesive tape; a layer B located between layer A and layer C; a layer C located between layer B and layer D; a layer D located between layer C and the outside, with layer D being the outmost lower layer of the adhesive tape. When also layer E is present, then layer D is located between layer C and layer E and layer E is located between layer D and the outside, with layer E being the outmost lower layer of the adhesive tape. A number of one of each of layers A-E is preferably used in the adhesive tape. Such tape may be an one sided tape.

The adhesive tape comprises a layer A located between layer B and the outside, layer A being the outmost upper layer of the adhesive tape; a layer B located between layer A and layer C; a layer C located between layer D and layer E; a layer D located between layer B and layer C and a layer E located between layer C and the outside, with layer E being the outmost lower layer of the adhesive tape when present or with layer C being the outmost lower layer of the adhesive tape when layer E is not present. The number of each layer A-E in the adhesive tape of this preferred embodiment is preferably 1. Such tape may be also an one sided tape.

The adhesive tape according to the present invention more preferably comprises a layer C located between layer B and the outside, with layer C being the outmost upper layer of the adhesive tape, a layer B located between layer C and layer A; a layer A located between layer D and layer B; a layer D located between layer A the outside, layer D being in this case the outmost lower layer of the adhesive tape or a layer D located between layer A and layer E when layer E is present, with layer E being in this case the outmost lower layer of the adhesive tape. Preferably, layer D is a holt melt adhesive, more preferably LDPE. By using such an adhesive tape construction, the adhesive tape costs are decreased, no fibrillation of the layer A occurs and it is possible to make different prints on the top layer C. A double sided adhesive tape of this type may also have said composition and in addition to this may have a second layer of the first adhesive as the outmost upper layer of the adhesive tape located on top of layer C.

The adhesive tape according to the present invention most preferably comprises a layer C located between layer D and the outside, with layer C being the outmost upper layer of the adhesive tape, a layer D located between layer C and layer A; a layer A located between layer D and layer B; a layer B located between layer A the outside, layer B being in this case the outmost lower layer of the adhesive tape or a layer B located between layer A and layer E when layer E is present, with layer E being in this case the outmost lower layer of the adhesive tape. Preferably, layer D is a pressure sensitive adhesive, more preferably a modified acrylic adhesive. By using such an adhesive tape construction, the adhesion of layer C to layer A is increased, no fibrillation of the layer A occurs and it is possible to make different prints on the top layer C. A double sided adhesive tape of this type may also have said composition and in addition to this may have a second layer of the first adhesive as the outmost upper layer of the adhesive tape located on top of layer C.

The adhesive tape according to the present invention may comprise or consist of one layer A, two layers B and optionally two layers E. Preferably, the adhesive tape according to the present invention comprises or consists of one layer A, two layers B, two layers C, two layers D, with layers D being in this case the outmost lower and upper layers of the adhesive tape and optionally two layers E, in which case layers E being the outmost lower and upper layers of the adhesive tape. Such an adhesive tape may be also referred to herein as a two sided adhesive tape i.e. it adheres with both sides on surfaces. More preferably, the double sided adhesive tape may comprise layer A as a core and two layers B, each layer B being located on each side of layer A, with layers B being in this case the outmost lower and upper layers of the adhesive tape and optionally two layers E, each layer E being located between one layer B and the outside, with layers E in case present being the outmost lower and upper layers of the adhesive tape. When layers C and D are additionally present, then the double sided adhesive tape comprises layer A as a core and two layers B, each layer B being located on each side of layer A, two layers C, each layer C being located between one layer B and one layer D; two layers D, each layer D being located between one layer C and one layer E and two layers E, each layer E being located between one layer D and the outside, with layers E in case present being the outmost lower and upper layers of the adhesive tape or when layers E are not present, than with layers D being the outmost lower and upper layers of the adhesive tape.

Preferably, all layers in the adhesive tape according to the present invention overlap over a major part of their surface as such adhesive tape shows suitable properties, such as high strength during use in a large variety applications, e.g. over at least 60%, preferably over more than 80% of their surface, preferably such that the layers overlap substantially over their entire surface (about 100% over their entire surface). Layers A, B, C, D and E are preferably continuous layers in the width.

The adhesive tape according to the present invention may further comprise a multilayered film that may be located on top of all layers forming the adhesive tape (between the upper or lowest layer and the outside of the adhesive tape) and being the outmost upper layer of the adhesive tape, e.g. located on top of layer A (e.g. between layer A and the outside), wherein the multilayered film comprises at least one film layer (B1) comprising a polyolefin and optionally at least one film layer (B2) comprising a polymer. Said multilayered film may be used to prevent the formation of loose tape filaments and makes the adhesive tape more suitable for applying a coating or a dye and more scratch resistant.

The thickness of the film layer (B1) may be between 0.005 mm and 0.5 mm, more preferably between 0.006 and 0.4 mm and most preferably between 0.004 and 0.08 mm and even most preferably between 0.005 and 0.04 mm. Preferably, the thickness of the film layer (B1) is at least 0.006, yet more preferably at least 0.007 mm, yet more preferably at least 0.01 mm, most preferably at least 0.02 mm, yet most preferably at most 0.04 mm and even most preferably at least 0.06 mm. A thinner film layer (B1) may deteriorate its adhesion to the layer A in the adhesive tape according to the invention. Preferably, the thickness of the film layer (B1) is at most 0.3 mm, more preferably at most 0.2 mm, yet more preferably at most 0.1 mm, yet more preferably at most 0.09 mm or even at most 0.08 mm or at most 0.04 mm. The film layer (B1) may comprise a polyethylene, more preferably a low molecular weight polyethylene, even more preferably low density polyethylene (LDPE) or linear preferably low density polyethylene LLDPE and most preferably LDPE as the mechanical properties of the adhesive tape improve, i.e. the amount of cracks and/or delamination between the layers in said adhesive tape decreases and the adhesion between the layers increase. In addition, a film layer (B1) comprising a polyethylene and preferably LDPE prevents loose filaments being formed on the layer A. Also, it improves the smoothness, abrasion resistance, scratch resistance of the surface and the aesthetics of the adhesive tape according to the invention. The multilayered film may comprise between 1 and 7 film layers (B1), more preferably between 1 and 5 film layers (B1), yet more preferably 1 or 3 film layers (B1).

The polymer in said film layer (B2) may be a polymer selected from a group comprising a polyolefin and a polar polymer, the polar polymer being preferably a polyamide or a polyester. Preferably, the polymer in said film layer (B2) is a polymer selected from a group consisting of a polyolefin and a polar polymer. Most preferably, said film layer (B2) comprises a polymer selected from a group comprising polyethylene, preferably high low density polyethylene (HDPE) or a polypropylene, e.g. a polypropylene homopolymer or propylene-based copolymer. Most preferably, said film layer (B2) comprises a polymer selected from a group comprising polypropylenes; polyethylenes, e.g. high density polyethylene (HDPE); polyurethanes, e.g. aliphatic or aromatic polyurethanes comprising ether or ester groups; polyacrylates, e.g. PMMA; epoxy resins; polyacetates, e.g. ethyl-vinyl acetate; polycarbonates; polyesters, e.g. polyethylene terephthalate (PET), polybutylene terephthalate (PBT); polyamides, e.g. polyamide-6, polyamide-6,6; acrylonitrile butadiene styrene (ABS); polystyrenes, polyamines. The multilayered film may comprise between 1 and 7 film layers (B2), more preferably between 1 and 3 film layers (B2).

Each of the layers (B1) and (B2) may also further comprise any additives known in the art, in any conventional amounts, such as various fillers, pigments and additives, e.g. flame-retardants, stabilizers, e.g. ultraviolet (UV) stabilizers, colorants, pigments, e.g. white pigment, dyes. The amount of the various fillers, pigments and additives may be between 0 and 30 wt %, more preferably between 0.05 and 20 wt %.

The present invention may also relate to the adhesive tape as described herein comprising a layer A comprising at least one anisotropic tape, wherein said anisotropic tape comprises ultrahigh molecular weight polyethylene; and a layer B comprising a first adhesive being a pressure sensitive adhesive.

The invention also relates to a process to make the adhesive tape according to the present invention, said process comprising the step of forming an assembly comprising a stack of a layer A comprising at least one anisotropic tape, wherein the tape comprises ultrahigh molecular weight polyethylene and layer A covers at least 60% of the surface area of layer B; at least one layer B comprising a first adhesive, optionally at least one layer C comprising a carrier, optionally at least one layer D comprising a second adhesive and optionally at least one layer E comprising a material.

The layers A-E may each be applied to form the adhesive tape according to the present invention by any method known in the art, for instance as a freestanding coating films, by lamination. For example, layers B and D may be individually applied by hot melting. For instance, stacking of the layers may be done by any method known in the art, e.g. by applying pressure (e.g. about 1 MPa) and/or by applying a temperature, e.g. below the melting point or the glass transition temperature of layers A and C but higher than the melting point or the glass transition temperature of layers B and D. After pressing the stack of layers, the assembly may be cooled under pressure to preferably room temperature, after which the pressure may be released.

Preferably, the stacking of the layers A-E is carried out such that the layers A-E overlap over a major part of their surface, e.g. over at least 60%, preferably at least 80% of their surface, preferably such that the layers overlap substantially over their entire surface (about 100% over their entire surface).

Furthermore, the invention also directs to an adhesive tape obtainable by the process as described herein, wherein the adhesive tape comprises a layer A comprising at least one anisotropic tape comprising ultrahigh molecular weight polyethylene; and a layer B comprising a first adhesive; optionally a layer C comprising a carrier; optionally a layer D comprising a second adhesive; and optionally a layer E comprising a material, wherein layer A covers at least 60% of the surface area of layer B. The components of such an adhesive tape (e.g. layers A-E), their characteristics and preferred embodiments are as described herein.

The present invention also relates to an article comprising the adhesive tape according to the present invention or to an adhesive tape obtainable by the process according to the invention, as described herein.

Moreover, the present invention also relates to the use of the adhesive tape according to the present invention particularly as repair kit, as construction part and as reinforcement, in the fields of: heat management in e.g. electronics field (as heat spot reduction); radomes; sports (e.g. sails, hockey and lacrosse sticks, surfboards, kayaks), automotive (panels used in cars); aviation; marine (e.g. in boats, repairing boat hulls after impact damage); renewable energy (e.g. wind and blade repair); in anti-icing applications; as erosion protection against harsh environmental conditions (e.g. sand erosion for helicopter blades); clothing; damaged metal (e.g. splicing tape in a continuous belt); paper and printing; filtration and venting; furniture (e.g. replacement of screws in assembling furniture, reinforcement in ply wood); packaging; luggage; medical (e.g. orthopedics); cables; sling splicing (e.g. slings of at least 2 turns of adhesive tape); constructions; infrastructure repairs; earthquake protection; storm and hurricane protection; snow fences and tents; car aero patch; space crafts; pipes; containers; strapping tapes (e.g. replacement of lashing or straps); logistics (e.g. pallets). The ease of application of the adhesive tape, together with its excellent load transfer performance makes it particularly suitable for temporary repairs under harsh environments. The adhesive tape according to the present invention can also be used in cut resistant applications. The adhesive tape according to the present invention in the above-mentioned applications is stronger, it shows higher load transfer capacity between adherent surfaces and higher degree of peeling strength on different types of substrates (i.e. higher adhesion force on a substrate, including on low energy substrates, also at harsh environmental conditions), and in the same time has a low degree of fibrillation and of splitting, particularly in its length direction. Additional advantages of the adhesive tape according to the present invention include higher thermal conductivity.

It is noted that the invention relates to all possible combinations of features recited in the claims. Features described in the description may further be combined.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention will be further elucidated with the following examples without being limited hereto.

### EXAMPLES

### Methods of Measurement

Thickness of any one of the layers in the adhesive tape according to the invention was measured with a micrometer on an original location and on eight peripheral locations, said peripheral locations being within a radius of at most 0.5 cm from the original location, and averaging the values.
Tensile properties, e.g. tensile strength and tensile modulus of the adhesive tape and of the tapes and of films according to this invention were defined from tensile testing. The width and thickness of the tapes were measured with a micrometer having an accuracy of 1 micron for the thickness and with a Vernier caliper with 100 microns accuracy for the width. The cross section area was obtained by multiplying width and thickness and expressed as square mm (mm²). Clamping was done in such a way that clamping damage was prevented, e.g. was done by draping the ends of the tapes around a circular bar, thus allowing load introduction by the capstan effect. The encircling around the circular bar was 180 degree and then the bar was clamped with mechanical means. A nominal gauge length of the tape of 440 mm and a crosshead speed of 50 mm/min were chosen. Tensile strength was obtained by measuring the breaking force, expressing it in newton and dividing that breaking force by the cross section area. The resulting breaking stress in N/mm² is identical to a stress expressed in MPa (1 MPa=1 N/mm²). A modulus was obtained by adding reflective markers on the tape and measuring elongation (increase of distance between the markers) with optical means. The strain was then obtained by dividing the distance increase by the original distance. A modulus was obtained by dividing the stress difference by the according strain. Typically the modulus was obtained at a strain of about 0.15%, where initial setting of the specimens in the clamps and straightening was completed, but non-linearites occurring at higher strains were not yet present.
Peeling strength was measured by measuring the adhesion force in cN/20 mm per tape width of the adhesive tape on different substrates at a peel angle of 180°, a peel speed of 300 mm/min, by using a test equipment Dynamo Tester Zwicki TRB43/009, at different conditions (temperature, time, relative humidity). The substrates to which an adhesive tape was applied on were first cleaned by using an alcohol, e.g. isopropyl alcohol and then the adhesive tape was applied on each substrate with a 2 kg hand roller.
Shear tests were done by connecting two aluminum strips with adhesive tape. The adhesive tape was applied at one side of the strips only. However, for comparative experiments the strength was so low that tape was applied at both sides of the aluminium strips, thus doubling the strength. The connected strips were then loaded in tension. Thus forcing the tension load to be transferred from the strips to the tape, via the adhesive interface. The length of each strip was 150 mm. The surface of commercially available aluminum strips was cleaned with isopropyl alcohol and then dried until no wet spot was seen. On two of the aluminum strips with a gap length between the aluminum strips of 1 mm, a 25 mm wide adhesive tape (covering thus entire width of the strips) according to the invention, or as a comparative experiment was attached and consolidated with a hand-roller, the tape having different overlap lengths (25 mm; 35 mm; 45 mm and 50 mm on each aluminium strip). After 72 h the shear tests were done by measuring the tensile strength on these samples and also on the samples with commercially available adhesive tapes that were prepared in the same way. Breaking force and fracture location was observed. The strength result can be recalculated to an average shear stress in the adhesive at the moment of fracture. This was done by dividing the force at fracture by the total surface covered by adhesive tape on one strip. This average shear stress was a measure of adhesive tape performance.
Intrinsic Viscosity (IV) for UHMWPE was determined according to method PTC-179 (as described in Hercules Inc. Rev. Apr. 29, 1982) at 135° C. in decaline, the dissolution time being 16 hours, with DBPC as anti-oxidant in an amount of 2 g/I solution, by extrapolating the viscosity as measured at different concentrations to zero concentration.
Contact angle was determined by initially cleaning the surface of the samples (e.g. the tape as obtained as disclosed herein below in section in Production of a solid state tape comprising UHMWPE) with an alcohol. The alcohol is chosen such that it does not dissolve the samples. The alcohol used for cleaning the samples was ethanol. Then, a small droplet (preferably between 3 and 5 microliters) of water was added to the surface of the sample. The droplet size was 5 microliters. Subsequently, the contact angle between the droplet and the sample was measured using a microscope. This measurement can be repeated for at least 3 times (it was repeated 5 times herein) and the average value of the contact angle values obtained from the results was measured.

### Production of a Solid State Tape Comprising UHMWPE

A powder bed of UHMWPE powder was compacted in a double belt press at a pressure of 40 bar and a temperature of 130° C. The aerial density of the powder bed was 1 kg per square meter. The resulting product was compressed between two calendar rolls at a temperature of 135° C., down to a thickness of 0.27 mm (270 microns) and subsequently was drawn with a factor 10 in an oven at 147° C. and then it was drawn again in another oven with a factor 2.5 at a temperature of 150° C. The resulting oriented tape had a thickness of 0.042 mm (42 microns), a tensile strength of 1.7 GPa, a tensile modulus of 115 GPa and a width of 35 cm. The ratio of tensile strength of the tape in longitudinal direction to tensile strength of the tape in transversal direction was 150.

### Production of Woven Sheets Comprising UHMWPE

4 monolayers of the tape as obtained as described under Production of a solid state tape comprising UHMWPE, each monolayer containing a 10 cm width and 0.042 mm thick solid-state UHMWPE tape produced as described herein above, were woven into two plain woven structures, each plain woven structure containing 2 monolayers consisting of said tapes. The two plain weave structures were stacked on top of each other under ambient condition in a 0.90° cross-plied manner to produce one fabric sheet layer having 4 monolayers, each monolayer consisting of said tape. The obtained sheet was cut in a sheet sample having a width of 40 cm, a length of 40 cm and a thickness of 0.168 mm, a tenacity of 8.5 cN/dTex in the 0.90° direction of the tape and an area density of 168 g/m².

### Example 1

An adhesive tape was obtained by applying a double sided 0.1 mm (100 microns) thick adhesive sheet (commercially available from Nitto under the trade name 5015P) made of a layer of a modified acrylic adhesive of 0.044 mm (44 microns) thick (layer B), a 0.012 mm (12 microns) thick PET carrier layer (layer C) and a modified acrylic adhesive of 0.044 mm (44 microns) thick (layer D) on a tape obtained as described herein above under Production of a solid state tape comprising UHMWPE, which was treated in advance by applying a Corona treatment at 400 Watt min/m² to increase the surface tension of the tape (layer A), obtained as described herein above. Layer A tape covered about 100% of the surface area of first adhesive layer B. A siliconised paper (layer E) commercially available from Mondi, type S-liner that is a super-calendared kraft paper liner was then applied as a release liner on the adhesive sheet between layer D and the outside. The obtained tape had the structure of layer A located between layer B and the outside, with layer A being the outmost upper layer of the adhesive tape; layer B located between layer A and layer C; layer C located between layer B and layer D; layer D located between layer C and layer E and layer E is located between layer D and the outside, with layer E being the outmost lower layer of the adhesive tape All layers A-E overlapped substantially on their entire width. The orientation direction of the UHMWPE tape (layer A) in Example 1 was in the load direction. The ratio of tensile strength of the adhesive tape in longitudinal direction to tensile strength of the adhesive tape in transversal direction was 21. Table 1 shows the results of measuring the tensile strength of the adhesive tape obtained with Example 1. Table 2 shows the results of measuring the shear tests of the adhesive tape obtained with Example 1.

### Example 2

Example 1 was repeated with the only difference that the adhesive tape was obtained in a two-step process. In the first step, a commercially available bi-laminate commercially available from EK-Pack Folien under the trade name EK Ester 12/30 comprising a LDPE hot melt adhesive with a thickness of 30 micron (0.03 mm) (layer D) and a layer comprising polyethylene terephthalate (layer C) having a thickness of 12 micron (0.012 mm), was applied on a tape obtained as described herein above under Production of a solid state tape comprising UHMWPE (layer A), which was not treated by applying the Corona treatment. In the second step, layer A (having on one side by layers C-D), was treated by applying a Corona treatment at 400 Watt min/m² to increase the surface tension of the tape (layer A), and then a pressure sensitive adhesive layer with a thickness of 0.04 mm (40 micron) was applied (layer B), the PSA being a modified acrylate adhesive commercially available from Nitto under the trade name 5015T. A siliconised paper (layer E) having 0.1 mm thickness was then applied as a release liner on the outside of the adhesive tape, between layer B and the outside. The adhesive tape had the structure of layer C located between layer D and the outside, with layer C being the outmost upper layer of the adhesive tape, layer D located between layer C and layer A; layer A located between layer D and layer B; layer B located between layer A and layer E, with layer E being the outmost lower layer of the adhesive tape. All layers A-E substantially overlapped substantially on their entire width. The orientation direction of the UHMWPE tape (layer A) in Example 2 was in the load direction. The ratio of tensile strength of the adhesive tape in longitudinal direction to tensile strength of the adhesive tape in transversal direction was 21. The adhesive tape obtained with Example 1 showed similar tensile strength as the adhesive tape obtained with Example 1 (Table 1). Table 2 shows the results of measuring the shear tests of the adhesive tape obtained with Example 2.

### Comparative Experiment 1 (CE1)

A solid state tape as obtained as described herein above under Production of a solid state tape comprising UHMWPE was analyzed and the results are shown in Table 1.

### Comparative Experiment 2 (CE2)

An adhesive tape commercially available from Nitto under the name No. 443 was analysed. This is a pressure-sensitive adhesive tapes with a release liner and an ultrahigh-molecular-weight polyethylene isotropic film base and contains an acrylic adhesive layer having a thickness of 0.17 mm.

### Comparative Experiment 3 (CE3)

An adhesive tape commercially available from Nitto under the name No. 4430 was analysed. This is a pressure-sensitive adhesive tape with a release liner and an ultrahigh-molecular-weight polyethylene isotropic film base and contains an acrylic adhesive layer having a thickness of 0.03 mm.

### Comparative Experiments 4 (CE4)

A commercially available adhesive tape Duct tape (CE3) was analysed. The results are shown in Table 2.

### Comparative Experiment 5 (CE5)

A commercially available adhesive tape Marko superkraftband tape (CE4) was analysed. The results are shown in Table 2.

### Comparative Experiment 6 (CE6)

5 layers of a commercially available adhesive tape Duct tape (CE3) were applied on top of each other, overlapping with each other. This was done as another attempt in order to reach a higher strength with commercial adhesive tapes. The obtained adhesive tape was analysed. The results are shown in Table 2.

### Comparative Experiment 7 (CE7)

7 layers of a commercially available adhesive tape Duct tape (CE3) were applied on top of each other, overlapping with each other. This was done as another attempt in order to reach a higher strength with commercial adhesive tapes. The obtained adhesive tape was analysed. The results are shown in Table 2.

### Comparative Experiment 8 (CE8)

Example 1 was repeated with the same adhesive tape according to the invention, but now the orientation direction of tape layer A was perpendicular to the load direction.

TABLE 1

| | Tensile strength, |
|---|---|
| Sample | Fmax [N] |
| Example 1 | 6128 |
| Example 2 | 6097 |
| CE 1 | 4883 |

TABLE 2

| | | Shear | Average | |
|---|---|---|---|---|
| | | test— | shear | |
| | | tensile | stress | |
| | | strength, | at | |
| | Overlap length | Fmax | fracture | |
| Sample | on each [mm] | [N] | [N/mm2] | Fracture type |
| Ex 1 | 25 (on one side | 1025 | 1.64 | Along adhesive |
| | of the strips) | | | interface |
| Ex 1 | 35 (on one side | 1078 | 1.23 | Along adhesive |
| | of the strips) | | | interface |
| Ex 1 | 45 (on one side | 1743 | 1.55 | Along adhesive |
| | of the strips) | | | interface |
| Ex 1 | 50 (on one side | 1681 | 1.34 | Along adhesive |
| | of the strips) | | | interface |
| Ex 2 | 25 (on one side | 950 | 1.52 | Along adhesive |
| | of the strips) | | | interface |
| Ex 2 | 35 (on one side | 1221 | 1.40 | Along adhesive |
| | of the strips) | | | interface |
| Ex 2 | 45 (on one side | 1341 | 1.19 | Along adhesive |
| | of the strips) | | | interface |
| Ex 2 | 50 (on one side | 1429 | 1.14 | Along adhesive |
| | of the strips) | | | interface |
| CE2 | 50 (on both sides | 123 | 0.05 | Through tape |
| | of the strips) | | | material |
| CE3 | 50 (on both sides | 100 | 0.04 | Through tape |
| | of the strips) | | | material |
| CE4 | 50 (on both sides | 218 | 0.09 | Through tape |
| | of the strips) | | | material |
| CE5 | 50 (on one both | 317 | 0.13 | Through tape |
| | sides of the strips) | | | material |
| CE6 | 50 (on one both | 337 | 0.27 | Through tape |
| | sides of the strips) | | | material |
| CE7 | 50 (on one both | 393 | 0.31 | Along adhesive |
| | sides of the strips) | | | interface |
| CE7 | 40 (on one both | 358 | 0.36 | Along adhesive |
| | sides of the strips) | | | interface |
| CE8 | 50 | 81 | 0.065 | Through tape |
| | | | | material |

The results in Table 1 clearly show that the adhesive tape according to the present invention (Example 1 and Example 2) is about 25% stronger than the tape of CE 1. In addition, the adhesive tape according to the present invention shows higher transfer capacity between adherent surfaces compared to the adhesive tapes of the prior art (Table 2). Also, the tensile strength of the adhesive tape according to the present invention is much higher than that of the commercial adhesive tapes. If judged in terms of average shear stress at fracture, about decade improvement is reached by the adhesive tape according to the present invention in comparison with the commercial adhesive tapes. Even by applying 5- or 7-fold commercial adhesive tape, the load transfer of such adhesive tapes was much lower than that of the adhesive tape according to the invention.

1. An adhesive tape comprising:
a) a layer A comprising at least one anisotropic tape, wherein said anisotropic tape comprises ultrahigh molecular weight polyethylene, and layer A covers at least 60% of the surface area of layer B; and
b) a layer B comprising a first adhesive being a pressure sensitive adhesive.

2. The adhesive tape according to claim 1, wherein the ratio of tensile strength in longitudinal direction to tensile strength in transversal direction of the at least one anisotropic tape is least 10, preferably at least 20, more preferably at least 30, and most preferably at least 50.

3. The adhesive tape according to claim 1, wherein layer A comprises at least one solid state anisotropic tape comprising UHMWPE.

4. The adhesive tape according to claim 1, wherein the thickness of the layer A is between at least 0.005 mm and at most 0.3 mm and preferably, between at least 0.03 mm and at most 0.05 mm.

5. The adhesive tape according to claim 1, wherein layer B is selected from a group comprising acrylic-based adhesives, rubber-based adhesives and water-based adhesives.

6. The adhesive tape according to claim 1, further comprising a layer C comprising a carrier, said carrier comprising preferably a material selected from a group comprising a polyester, a polyamide, a polyolefin, a polycarbonate, paper, tissue, a polymeric foam, a woven material, a non-woven material.

7. The adhesive tape according to claim 1, wherein layer C is polyethylene terephthalate.

8. The adhesive tape according to claim 1, further comprising a layer D comprising a second adhesive, preferably the second adhesive being a pressure sensitive adhesive or a hot melt adhesive, the pressure sensitive adhesive being selected from a group comprising acrylic-based adhesives, rubber-based adhesives and water-based adhesives or a hot melt adhesive.

9. The adhesive tape according to claim 1, further comprising layer E comprising a material preferably selected from a group comprising paper, a polymer and a metal.

10. The adhesive tape according to claim 1, wherein the adhesive tape comprises the layer A located between layer B and the outside, with layer C being the outmost upper layer of the adhesive tape; the layer B located between layer A and layer C; the layer C located between layer B and layer D; the layer D located between layer C and layer E and the layer E located between layer D and the outside, with layer E being in this case the outmost lower layer of the adhesive tape.

11. The adhesive tape according to claim 1, wherein the adhesive tape comprises layer C located between layer B and the outside, with layer C being the outmost upper layer of the adhesive tape, layer B located between layer C and layer A; layer A located between layer D and layer B; layer D located between layer A and layer E, with layer E being the outmost lower layer of the adhesive tape.

12. The adhesive tape according to claim 1, wherein the adhesive tape comprise layer C located between layer D and the outside, with layer C being the outmost upper layer of the adhesive tape, layer D located between layer C and layer A; layer A located between layer D and layer B; layer B located between layer A the outside, layer B located between layer A and layer E, with layer E being the outmost lower layer of the adhesive tape.

13. The adhesive tape according to claim 1, further comprising a multilayered film comprising at least one film layer comprising a polyolefin and/or at least one film layer comprising a polymer, the multilayer film being the outmost upper layer of the adhesive tape.

14. An article comprising the adhesive tape according to claim 1.

15. Use of the adhesive tape according to claim 1 cut resistant applications, in heat management applications, as repair kit, as construction part and as reinforcement part, in the fields of electronics, radomes, sports, automotive, aviation, marine, renewable energy, clothing, in anti-icing applications, damaged metal, paper and printing, filtration and venting, furniture, packaging, luggage, medical, cables, sling splicing, constructions, infrastructure repairs, earthquake protection, storm and hurricane protection, snow fences and tents, car aero patch, space crafts, pipes, containers, strapping tapes, logistics, erosion protection.
